(19) United States
(12) Patent Application Publication
(10) Pub. No.: US 2019/0202727 A1
(43) Pub. Date: Jul. 4, 2019

(54) Method and Device for Producing Hollow Microglass Beads

(71) Applicants: BPI Beads Production International GmbH, Bad Muskau (DE); Hofmeister Kristall GmbH, Cottbus (DE)

(72) Inventors: Jürgen Schlicke, Wiesbaden (DE); Lutz Stache, Cottbus (DE)

(21) Appl. No.: 16/311,786

(22) PCT Filed: Jun. 12, 2017
(86) PCT No.: PCT/DE2017/100490

§ 371 Date: Dec. 20, 2018

(30) Foreign Application Priority Data
Jun. 27, 2016 (DE) 10 2016 111 735.8
Sep. 19, 2016 (DE) 10 2016 117 608.7

(51) Int. Cl. C03B 19/10

(52) U.S. Cl. CPC C03B 19/1075

(57) ABSTRACT

The invention relates to a method and a device for producing hollow microglass beads (3.4) from molten glass (3), wherein the hollow microglass beads (3.4) are manufactured in a diameter range from 0.01 mm to 0.1 mm in a continuously operating process while avoiding glass filament formation. Molten glass strands (3.1) exiting a melting device (1) are atomized by means of hot gas (14) to form glass particles (3.2). Subsequently, during passage through a rounding/expansion duct (6), the glass particles (3.2) are rounded to form solid microglass beads (3.3) and expanded to form hollow microglass beads (3.4). The hollow microglass beads (3.4) can advantageously be used as a filler for lightweight building materials or as a constituent part of coatings, paints and plasters/renders.

### CROSS REFERENCE TO RELATED APPLICATIONS

This application is the U.S. national stage of International Application No. PCT/DE2017/100490, filed on 2017 Jun. 12. The international application claims the priority of DE 102016111735.8 filed on 2016 Jun. 27 and the priority of DE 102016117608.7 filed on 2016 Jun. 19; all applications are incorporated by reference herein in their entirety.

### BACKGROUND

The invention relates to a method and a device for producing hollow microglass beads in the diameter range from 0.01 mm to 0.1 mm from molten glass, which beads can be used inter alia as a filler for lightweight building materials or as a constituent part of coatings, paints and plasters/renders.

The production of solid microglass beads in the diameter range up to 0.015 mm is known from DE 10 2008 025 767 A1 or DE 197 21 571 A1, according to which molten glass particles are dispersed by means of a cutting wheel.

A comparable method for producing hollow glass beads is described in WO 2015/110621 A1. In order to be able to produce hollow microglass beads with diameters from 0.01 mm to 0.12 mm using this technology, very high cutting wheel speeds are necessary, wherein technical limits are encountered in the mounting of the cutting wheel (uneven running) and the cooling (wind formation). Consequently, hollow microglass beads in the required diameter range cannot be produced by this method.

DD 261 592 A1 describes a method for producing solid microglass beads in the diameter range from 0.040 mm to 0.080 mm from molten high-index glass. The molten glass in the form of a glass strand of approximately 4 mm to 6 mm diameter comes out of a platinum melting vessel and is atomised to form glass particles using a cold jet of compressed air with a velocity of 100 m s⁻¹ to 300 m s⁻¹ and a pressure of 300 kPa to 700 kPa. It is a disadvantage that, during the atomisation of soda-lime glasses, glass filaments are produced instead of the required glass particles.

The documents U.S. Pat. No. 2,334,578, 2,600,936, 2,730,841, 2,947,115, 3,190,737, 3,361,549, DE 1 019 806 A and also DE 1 285 107 A describe how cullet is ground, sifted and partially screened to the size of the solid microglass beads to be produced. The material is delivered to a temperature field in which, due to the surface tension, the individual glass particles take on a spherical shape during their passage through a heating zone. However, during the time-consuming grinding of the shards the grinding media and the mill are subject to substantial wear; moreover, with this method it is not possible to control the size of the glass beads.

DE 10 2007 002 904 A1 discloses a method for producing hollow glass beads from finely ground soda-lime glass and/or borosilicate glass by means of a heat transfer process (for example in a shaft furnace). As a result of the lowering of the viscosity of the glass particles, the temperature rising according to the method results in the production of glass beads due to the surface tension. Furthermore, the high temperature effects the gaseous emission of an added propellant. Consequently, the small solid beads grow to form larger hollow beads. Disadvantages are the costly crushing of the glass and the defective control of the hollow bead size, so that subsequent classification is necessary.

According to AT 175672 B, molten glass which runs out of a nozzle as a strand is dispersed by an intermittently acting hot air jet into glass particles which assume a spherical shape during the subsequent free fall. The intermittent hot air jet is created by a perforated rotating disc. Only comparatively large beads can be produced by this method.

Further methods for glass bead production are described in U.S. Pat. No. 2,965,921, 3,150,947, 3,294,511, 3,074,257, 3,133,80, AT 245181 B and also FR 1 417 414 A. With the methods referred to therein the fundamental problems and disadvantages, such as for example glass filament formation, low output, complicated atomisation systems, great fluctuation in the diameter of the microglass beads, are not prevented. The microglass beads must be subsequently cleaned of fibres by additional, extremely costly technological method steps. When liquid media are used, additional drying of the microglass beads is necessary.

### SUMMARY

The invention relates to a method and a device for producing hollow microglass beads (3.4) from molten glass (3), wherein the hollow microglass beads (3.4) are manufactured in a diameter range from 0.01 mm to 0.1 mm in a continuously operating process while avoiding glass filament formation. Molten glass strands (3.1) exiting a melting device (1) are atomized by means of hot gas (14) to form glass particles (3.2). Subsequently, during passage through a rounding/expansion duct (6), the glass particles (3.2) are rounded to form solid microglass beads (3.3) and expanded to form hollow microglass beads (3.4). The hollow microglass beads (3.4) can advantageously be used as a filler for lightweight building materials or as a constituent part of coatings, paints and plasters/renders.

### DETAILED DESCRIPTION

The object of the invention is to provide a method and a device for producing hollow microglass beads which makes it possible to manufacture the hollow microglass beads in a diameter range from 0.01 mm to 0.1 mm in a continuously operating process directly from molten glass while avoiding glass filament formation. The dispersion range of the diameter of the hollow beads produced according to the method should be less by comparison with currently known production methods.

According to the invention the production of the hollow microglass beads takes place by atomisation of a molten glass strand by means of a hot gas to produce glass particles, wherein, during a passage through a heated rounding/expansion duct following the atomisation, solid microglass beads are rounded and are subsequently expanded to form hollow microglass beads.

In a melting device, for example a platinum tank or a conventional melting tank, the glass is melted with a predetermined composition, wherein at least one substance which is gaseous in the range from 1100° C. to 1500° C. is contained in dissolved form in the glass melt.

In the bottom region of the melting device there is located a discharge opening, through which the glass melt exits in the form of one or more glass strands.

A nozzle plate with a plurality of nozzles formed as conical through openings is preferably arranged on or inside the discharge opening, so that a plurality of glass strands spaced apart from one another are produced at the outlet of the glass melt from the melting device. The nozzle plate is preferably directly electrically heated.

By means of a hot gas flowing out of a high-pressure hot gas nozzle, for example a natural gas/oxygen high-pressure burner, the molten glass strand or strands is or are atomised to form glass particles after the outlet from the melting device, wherein the glass particles produced have a more or less irregular configuration. The hot gas flow is preferably oriented at right angles to the glass strand or strands.

Due to the flowing hot gas the glass particles are subsequently blown directly into the immediately adjoining rounding/expansion duct oriented in the flow direction. During the passage through the rounding/expansion duct the rounding (spherical shaping) of the glass particles to produce solid microglass beads takes place, i.e. during the heating the glass particles take on a spherical shape or are transformed into beads as a result of the surface tension.

In the course of the further passage, by suitable temperature control in the rounding/expansion duct the expansion (inflation) of the solid microglass beads into hollow microglass beads takes place as a result of the degassing of the dissolved gaseous substance.

The rounding/expansion duct is operated in the temperature range from usually 1100° C. to 1500° C. by the hot gas and possibly by additional heating systems.

After the outlet from the rounding/expansion duct the hollow microglass beads are cooled by means of cooling air and collected in solid form.

One of the advantages of the invention is that, due to the high gas velocity and the high gas temperature of the hot gas flowing out of the high-pressure hot gas nozzle onto the glass strand or strands, the formation of glass filaments is avoided.

By compliance with constant conditions, namely the gas temperature, the gas velocity and the process temperature, a small dispersion range of the size of the hollow microglass beads is ensured which is in the diameter range from 0.02 mm to 0.05 mm. Costly subsequent classifications of the hollow microglass beads are omitted in fractions with a narrow diameter bandwidth.

The method makes it possible with continuous process management to produce high-quality hollow microglass beads cost-effectively and in large quantities per unit of time. Expensive method steps, such as for example the mechanical comminution of cold glass and the cost-intensive heating until the rounding takes place, are unnecessary.

At the outlet from the melting device the glass strands advantageously have a diameter from 0.5 mm to 1.5 mm.

The viscosity of the glass melt exiting as a glass strand is preferably 0.5 dPa s to 1.5 dPa s. With a given chemical composition of the glass melt, the setting of this viscosity range can take place by control of the melt temperature.

Furthermore, at the outlet from the melting device the glass strand or strands is or are subjected to a flow of the hot gas with a gas velocity in the range from 300 m s⁻¹ to 1500 m s⁻¹, preferably 500 m s⁻¹ to 1000 m s⁻¹. The temperature of the hot gas is set particularly suitably to a value between 1500° C. and 2000° C.

Soda-lime glasses or borosilicate glasses are preferably used for the method according to the invention. The glass compositions for particularly suitable soda-lime glasses or borosilicate glasses are apparent from the details according to Table 1.

TABLE 1
Preferred composition of the glasses for producing the hollow
microglass beads

| | Soda-lime glass | Borosilicate glass |
|---|---|---|
| | Proportion by | Proportion by |
| Constituents | mass/% | mass/% |
| SiO₂ | 60-64 | 65-74 |
| Na₂O | 15-18 | 1-2 |
| CaO | 16-18 | 1.0-1.5 |
| Al₂O₃ | 1.5-2.5 | 2-3 |
| B₂O₃ | 1-6 | 12-16 |
| SO₃ | 0.6-0.8 | — |
| As₂O₃ | — | 0.1-0.5 |
| Sb₂O₃ | — | 0.1-0.5 |
| BaO | — | 1-2 |
| ZrO₂ | — | 4-5 |
| ZnO | 2-4 | 1-4 |

It can be provided that the substance which is dissolved in the glass melt and is gaseous in the range from 1100° C. to 1500° C. is sulfur trioxide, oxygen, nitrogen, sulfur dioxide, carbon dioxide, arsenic oxide, antimony oxide or a mixture thereof.

In the case of sulfur trioxide (SO₃) the preferred proportion by mass is in the range from 0.6% to 0.8%, wherein the proportion of sulfur trioxide can be implemented for example by an addition of sodium sulfate in the glass melt. Furthermore, suitable dissolved, gaseous substances are arsenic oxide (AS₂O₃) or antimony oxide (Sb₂O₃) having a proportion by mass in the range from 0.1% to 0.5%.

Particularly advantageously, the respective proportion by mass of the dissolved substance is chosen as follows:
sulfur trioxide (SO₃)0.8%
antimony oxide (Sb₂O₃)0.5%
arsenic oxide (As₂O₃)0.5%

In an embodiment of the invention a transport gas is blown in axially into the rounding/expansion duct by means of a transport gas nozzle (of a transport burner). The flow direction of the transport gas corresponds to the duct direction and the injection takes place below the region in which the glass particles enter the rounding/expansion duct. The transport gas serves to keep the glass particles, the solid microglass beads as well as the hollow microglass beads suspended during the passage through the rounding/expansion duct and to assist the transport through the rounding/expansion duct. Furthermore, the transport gas can be used for heating the rounding/expansion duct.

The device for carrying out the method comprises the melting device with the discharge opening arranged in the bottom region, on which or inside which the nozzle plate is mounted in such a way that the glass melt can exit exclusively from the nozzles in thin glass strands. The high-pressure hot gas nozzle is located immediately below and alongside the discharge opening and is oriented so that when the method is being carried out the hot gas flowing out of the high-pressure hot gas nozzle impinges on the glass strands (3.1) exiting from the nozzles.

The rounding/expansion duct is located in the flow direction of the hot gas which, during operation, flows out of the high-pressure hot gas nozzle after the discharge opening.

Furthermore, for delivery of the cooling air the device has a cooling air funnel which adjoins the rounding/expansion duct, wherein the cooling air funnel and also the rounding/expansion duct are oriented in the flow direction of the hot gas. The funnel opening is facing the rounding/expansion duct. The funnel neck of the cooling air funnel forms a discharge duct for collecting the cooled hollow microglass beads.

The termination of the end region of the discharge duct arranged in the flow direction can be formed by a cyclone precipitator or a rotary feeder, by means of which the hollow microglass beads are continuously conveyed out of the discharge duct.

In one embodiment of the invention the nozzle plate has nozzles each having a circular cross-section and having a diameter in the range from 1 mm to 3 mm. This makes it possible to produce the glass strands in the diameter range from 0.5 mm to 1.5 mm which is particularly advantageous for the method.

Furthermore, it can be provided that the nozzles of the nozzle plate which are spaced apart from one another are arranged in a line. The positioning of the linear nozzle arrangement in the device takes place transversely with respect to the flow direction of the hot gas.

In this embodiment the nozzle plate can have two symmetrically curved reinforcing beads which extend in mirror image to one another along the linearly arranged nozzles. Heat-induced deformations or distortions of the nozzle plate are restricted by the reinforcing beads; a geometrically exact exit of the glass strands from the nozzle is guaranteed. The reinforcing beads can be formed for example in sheet metal components of the nozzle plate.

This nozzle plate is preferably made from a platinum material.

### BRIEF DESCRIPTION OF THE DRAWINGS

The invention is explained in greater detail below on the basis of embodiments and with reference to the schematic drawings. In the drawings:

FIG. 1 shows the device for carrying out the method for producing hollow microglass beads, and

FIG. 2 shows the nozzle plate with five nozzles in top view and in cross-section.

### DETAILED DESCRIPTION OF THE PREFERRED EMBODIMENTS

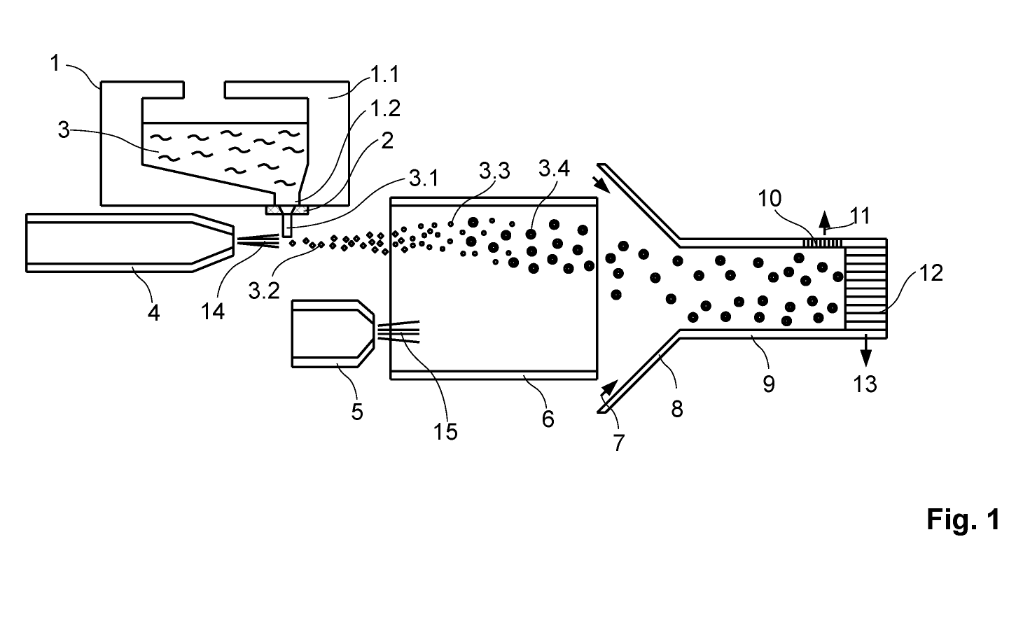

According to a first exemplary embodiment according to FIG. 1, soda-lime glass is melted with a proportion by mass of 0.8% of sulfur trioxide in the melting device 1, an electrically heated platinum melting vessel, at 1450° C. By means of the discharge opening 1.2 in the bottom of the melting device 1, molten glass 3 enters through the electrically heated nozzle plate 2 made of platinum with 20 linearly arranged nozzles 2.1 with a respective diameter of 1.5 mm out of the melting device 1. The viscosity of the glass melt 3 is 0.5 dPa s. The exiting molten glass strands 3.1 with a diameter of 0.7 mm are atomised immediately after the exit from the nozzle 2.1 by the hot gas 14 from the high-pressure hot gas nozzle 4 of an oxygen/natural gas high-pressure burner to form glass particles 3.2. In this case the hot gas flows at right angles against the glass strands 3.1 with a gas velocity of 600 m/s. Then the glass particles 3.2 enter the immediately adjoining rounding/expansion duct 6 which is made from refractory material and is longitudinally heated by means of the transport gas 15 from the transport gas nozzle 5 of a transport gas burner.

The temperature in the rounding/expansion duct 6 is 1500° C. The solid microglass beads 3.2 initially formed from the glass particles 3.2 in the rounding/expansion duct 6 then expand to form hollow microglass beads 3.4 and ultimately enter the discharge duct 9 made from stainless steel. Cooling air 7 is blown into this duct via cooling air funnels 8 for cooling the exhaust gases, and then exits again at the end of the discharge duct 9 as exhaust air 11 through the sieve 10. The sieve 10 prevents the exit of the hollow microglass beads 3.4. These are conveyed out of the discharge duct 9 through the rotary feeder 12. The hollow microglass beads 3.4 have a diameter from 0.02 mm to 0.05 mm.

In a second exemplary embodiment borosilicate glass with a proportion by mass of 0.5% antimony oxide in einem conventional melter at a melting temperature of 1600° C. The molten glass 3 enters the feeder at a temperature of 1450° C. through an electrically heated discharge opening 1.2 with a sieve insert to keep refractory particles away from the electrically heated nozzle plate 2 with 22 linearly arranged nozzles 2.1 having a diameter in each case of 1.5 mm. The atomisation of the molten glass, the transport through the rounding/expansion duct 6 and the discharge correspond to those in the first exemplary embodiment. The diameter of the hollow microglass beads 3.4 is in the range from 0.02 mm to 0.04 mm.

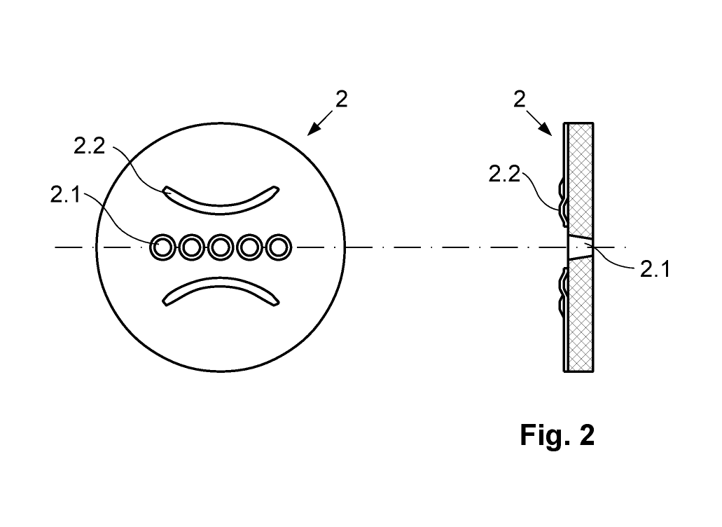

The nozzles 2.1 of the nozzle plate 2 according to FIG. 2 exhibit above and below the row of nozzles in each case a symmetrically curved reinforcing bead 2.2. The reinforcing beads 2.2 are formed in the sheet metal components of the nozzle plate 2.

### LIST OF REFERENCE NUMERALS

1 melting device/crucible
1.1 insulation
1.2 discharge opening
2 nozzle plate
2.1 nozzle
2.2 reinforcing bead
3 glass melt
3.1 glass strand, molten
3.2 glass particle
3.3 solid microglass bead
3.4 hollow microglass bead
4 high-pressure hot gas nozzle
5 transport gas nozzle
6 rounding/expansion duct
7 cooling air
8 cooling air funnel
9 discharge duct
10 sieve
11 exhaust air
12 rotary feeder
13 discharge of the hollow microglass beads
14 hot gas
15 transport gas

1. Method for producing hollow microglass beads, wherein a glass melt, which contains at least one substance in dissolved form which is gaseous in the range from 1100° C. to 1500° C., is produced in a melting device and the glass melt in the form of one or more molten glass strands exits from the melting device through a discharge opening, characterised in that
(a) the glass strands are produced with a diameter from 0.5 mm to 0.8 mm,
(b) by control of the temperature of the glass melt, the viscosity thereof as it exits as a glass strand is set to 0.5 dPa s to 1.5 dPa s;
(c) by means of a hot gas flowing out of a high-pressure hot gas nozzle, the molten glass strand or strands is or are atomised to form glass particles after the exit from the melting device,
(d) the glass particles are blown by the flowing hot gas directly into an immediately adjoining, heated, rounding/expansion duct oriented in the flow direction, wherein during the passage through the rounding/expansion duct the glass particles are transformed into solid microglass beads as a result of the surface tension during the heating, and the solid microglass beads then expand to form hollow microglass beads as a result of the degassing of the dissolved gaseous substances, and
(e) after the exit from the rounding/expansion duct the hollow microglass beads are cooled by means of cooling air and collected in solid form.

2. Method for producing hollow microglass beads according to claim 1, characterised in that a plurality of glass strands which are spaced apart from one another are produced, and a nozzle plate comprising a plurality of nozzles formed as conical through openings is used, in each case with a circular cross-section and with a diameter in the range from 1 mm to 3 mm, on or inside the discharge opening.

3. Method for producing hollow microglass beads according to claim 1, characterised in that the gas velocity of the hot gas as it impinges on the glass strand or strands is 300 m s⁻¹ to 1500 m s⁻¹.

4. Method for producing hollow microglass beads according to claim 1, characterised in that the temperature of the hot gas is 1500° C. to 2000° C.

5. Method for producing hollow microglass beads according to claim 1, characterised in that the glass melt used contains sulfur trioxide, oxygen, nitrogen, sulfur dioxide, carbon dioxide, arsenic oxide, antimony oxide or mixtures thereon in dissolved form.

6. Method for producing hollow microglass beads according to claim 5, characterised in that the glass melt used contains sulfur trioxide in a proportion by mass in the range from 0.6% to 0.8%.

7. Method for producing hollow microglass beads according to claim 5, characterised in that the glass melt used contains arsenic oxide or antimony oxide in a proportion by mass in the range from 0.1% to 0.5%.

8. Method for producing hollow microglass beads according to claim 1, characterised in that a transport gas is blown in axially by means of a transport gas nozzle into the rounding/expansion duct, in order to keep the glass particles, the solid microglass beads as well as the hollow microglass beads suspended and to assist the transport thereof through the rounding/expansion duct.

9. Device for carrying out the method according to claim 2, characterised in that
the discharge opening is arranged in the bottom region of the melting device, wherein the nozzle plate is mounted on or inside the discharge opening in such a way that the glass melt exclusively exit from the conically formed nozzles,
the nozzle plate has nozzles each having a circular cross-section and having a diameter in the range from 1 mm to 1.6 mm, wherein the nozzle plate can be heated electrically;
the high-pressure hot gas nozzle is positioned immediately below and alongside the discharge opening, wherein the high-pressure gas nozzle is oriented so that when the method is being carried out the hot gas flowing out of the high-pressure hot gas nozzle impinges on the glass strands exiting from the nozzles,
the rounding/expansion duct is arranged in the flow direction of the hot gas which, when the method is being carried out, flows out of the high-pressure hot gas nozzle after the discharge opening,
a cooling air funnel for delivery of the cooling air is positioned in the flow direction of the hot gas after the rounding/expansion duct, wherein the funnel opening is facing the rounding/expansion duct, and
the funnel neck of the cooling air funnel forms a discharge duct for collecting the cooled hollow microglass beads.

10. Device according to claim 9, characterised in that the end region of the discharge duct arranged in the flow direction terminates with a rotary feeder or a cyclone precipitator.

11. Device according to claim 9, characterised in that the nozzles of the nozzle plate are arranged in a line.

12. Device according to claim 11, characterised in that the nozzle plate has two symmetrically curved reinforcing beads ) which extend along the nozzle in mirror image to one another.
